(19) United States
(12) Patent Application Publication
(10) Pub. No.: US 2016/0212974 A1
(43) Pub. Date: Jul. 28, 2016

(54) ANIMAL CONTAINMENT DEVICE AND METHOD

(71) Applicant: Andries Petrus Cronje FOURIE, Johannesburg (ZA)

(72) Inventor: Andries Petrus Cronje FOURIE, Parkview (ZA)

(21) Appl. No.: 14/915,442

(22) PCT Filed: Aug. 29, 2014
(86) PCT No.: PCT/IB2014/064146

§ 371 Date: Feb. 29, 2016

(30) Foreign Application Priority Data
Aug. 29, 2013 (ZA) 2013/06502

(51) Int. Cl. A01K 15/02

(52) U.S. Cl. CPC A01K 15/023

(57) ABSTRACT

This invention relates to a device and method for containing animals, and more particularly, but not exclusively, to a device and method for containing domesticated animals within a set perimeter (19). According to a first aspect of the invention there is provided an animal containment device comprising at least one magnet (12) for setting a perimeter (19); and a transceiver securable to an animal, the transceiver configured to detect a magnetic field emitted from the magnet, the transceiver further being provided with alerting means, wherein the alerting means is configured to emit a signal when the transceiver detects the magnetic field.

### INTRODUCTION AND BACKGROUND

This invention relates to a device and method for containing animals, and more particularly, but not exclusively, to a device and method for containing domesticated animals within a set perimeter.

Pets and other domesticated animals often need to be contained within or prevented from entering certain areas in an around the home and yard. Various devices for achieving this objective are known in the art.

The most common solution to contain animals within a certain area, or preventing animals from entering a certain area, involves physical construction of a fence or boundary wall. Disadvantages hereof include that said construction can be both costly and visually unsightly. A further disadvantage is that it may also hinder human movement into and out of such areas.

Another known device comprises an invisible electronic pet fence. These fences train animals not to exit a fixed area. Said device utilises a signal generator or energiser connected to an electrical outlet, which generator or energiser is connected to a wire through which an electric current flows, emitting a low frequency radio signal. This wire is typically in a closed loop that is buried underground so that it surrounds the area within which a pet is to be contained. A collar for the animal is also provided. Said collar is provided with a low frequency wireless transceiver, means of administering a static pulse as well as an audible warning emitter. Said collar senses proximity of the wire. The collar issues an audible warning tone to the animal as it moves closer to the wire boundary. If the animal moves beyond a certain point in relation to the wire, a static pulse stimulus is administered by the collar which discourages the animal to approach or cross the wire boundary.

A disadvantage of this electronic pet fence is that it needs a continuous loop of wire to establish a closed electronic circuit. Said device accordingly lacks customisability, making it relatively difficult to allow animals access to certain areas whilst preventing them access to other adjacent areas.

A yet further disadvantage of such fences is that the electronic circuit requires an electrical supply to operate. This increases the costs of installation and operation of the system and brings about the risk that the system can be rendered inoperable, at least temporarily, in the event of interruption or loss of electricity supply. This risk will remain notwithstanding provision of a back-up electricity supply, such as a back-up battery. Installation of such back-up electricity supply will yet furthermore increase the costs and maintenance of the fence.

Yet another disadvantage of known electronic pet fences is that the wire installation often proves to be cumbersome. The wire needs to be buried underground or even underneath walkways or paved surfaces, introducing a risk of the wire being severed at a later stage by excavation or other gardening activities. Possible corrosion of the wire underground is also a perceived disadvantage of electronic pet fences.

An even further disadvantage associated with known electronic pet fences is that the devices are relatively expensive, which disadvantage is amplified if more than one area needs to be provided with an electronic fence and more than one energiser or generator and closed wire loop accordingly has to be installed.

### OBJECT OF THE INVENTION

It is accordingly an object of the current invention to provide an animal containment device and method with which the above disadvantages associated with known devices and methods for containing animals could at least partially be overcome or alleviated.

### SUMMARY OF THE INVENTION

According to a first aspect of the invention there is provided an animal containment device comprising:
at least one magnet for setting a perimeter; and
a transceiver securable to an animal, the transceiver configured to detect a magnetic field emitted from the magnet, the transceiver further being provided with alerting means, wherein the alerting means is configured to emit a signal when the transceiver detects the magnetic field.

Further according to the invention, the magnet may be a ferromagnet. Alternatively, the magnet may be an electromagnet.

The ferromagnet may be a permanent magnet selected from the group consisting of neodymium iron boron magnets; samarium cobalt magnets; alnico magnets and ceramic magnets.

The one or more magnets may all be polarly directed in a same direction. Alternatively, the magnets may be polarly directed in alternating directions.

Still further according to the invention, the transceiver may be fitted to a collar worn by a pet.

The signal emitted by the alerting means may be an auditory signal. The volume and tempo of recurrence of the auditory signal may be adjustable relative to the distance between the magnet and the transceiver.

Even further according to the invention, the signal emitted by the alerting means may be a static pulse delivered to the animal if it comes too close in proximity to the magnet or crosses the perimeter set by the magnet, thereby dissuading the animal from breaching said perimeter. The intensity of the static pulse delivered by the alerting means may be adjustable.

Yet further according to the invention, the magnets may be buried underground to set a perimeter. Alternatively, the magnets may be affixed to or placed approximate to a structure in the proximity of which an animal's presence is unwanted, thereby setting a perimeter around said structure to prevent animals from approaching or damaging said structure.

According to a second aspect of the invention there is provided a method for containing animals within a set perimeter comprising the steps of:
setting a perimeter using at least one magnet;
securing a transceiver, configured to detect a magnetic field emitted from the magnet and further being provided with alerting means, to an animal; and
the alerting means emitting a signal when the transceiver detects the magnetic field.

### BRIEF DESCRIPTION OF THE ACCOMPANYING DIAGRAMS

The invention will now be described further by way of a non-limiting example(s) with reference to the accompanying drawings wherein:

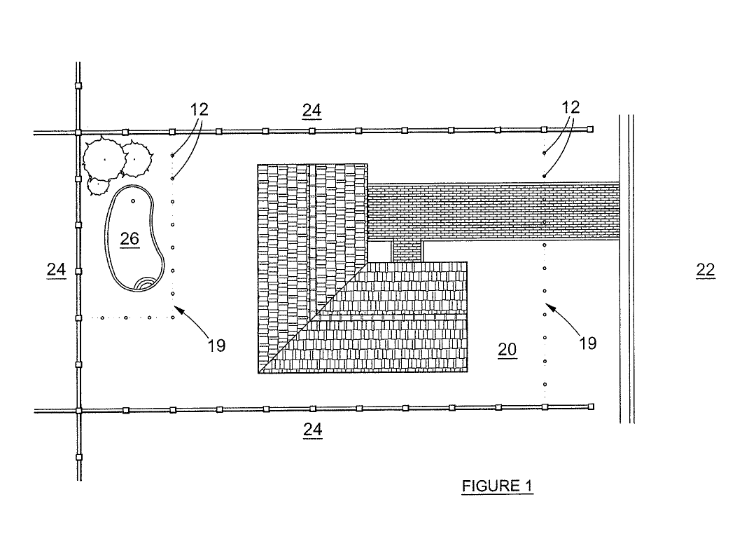

FIG. 1: is a plan view of a domestic yard showing perimeters set by using the device and method according to the invention; and

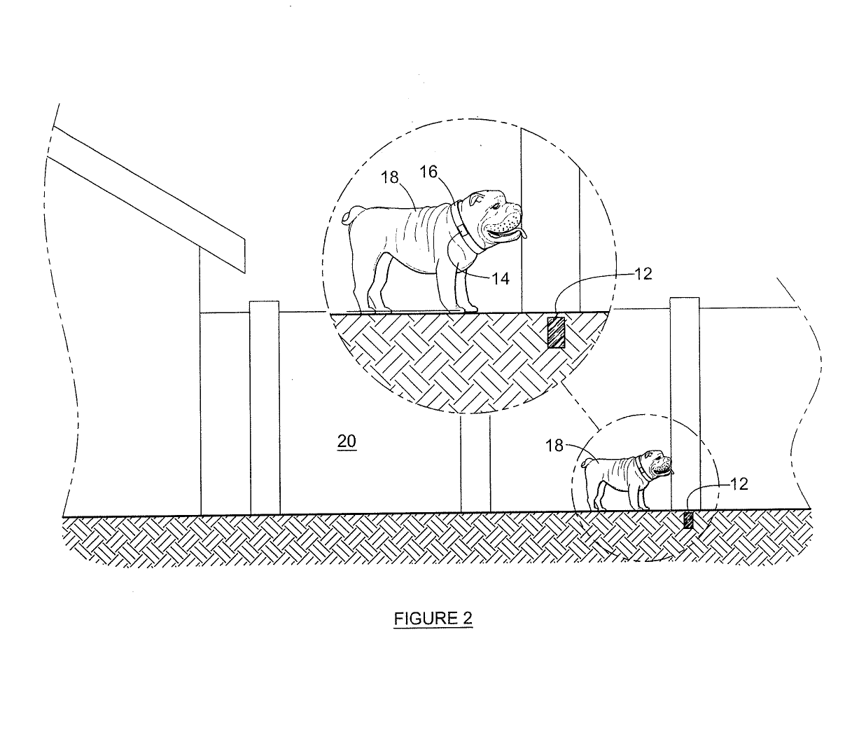

FIG. 2: is a plan view of a dog wearing a collar fitted with a transceiver according to the invention.

### DESCRIPTION OF A PREFERRED EMBODIMENT OF THE INVENTION

Referring to FIGS. 1 and 2, an animal containment device according to a preferred embodiment of the invention comprises at least one magnet 12 and a transceiver 14 fitted to collar 16 on dog 18. The transceiver 14 is capable of detecting a magnetic field emitted from the magnet 12, and the transceiver 14 is further provided with alerting means (not shown). The alerting means emits a signal when the transceiver 14 is activated by the magnetic field emitted from the magnet 12. The magnet 12 may be provided as a ferromagnet or an electromagnet and will be determined according to the requirements of a particular installation.

The transceiver 14 is also provided with a stimulus generator (not shown) that comes into contact with the skin of the dog 18 wearing the collar 16 fitted with transceiver 14. The stimulus generator is capable of emitting a static pulse to the dog 18 to deter the dog from crossing a perimeter 19 set by the one or more magnets.

As shown in FIG. 1, it is often necessary to fence in animals in a yard to prevent animals from running into the street 22, neighbouring areas 24 or other areas, such as the swimming pool 26, where the presence of animals may be unwanted. With the containment device according to the invention, a perimeter 19 is set up by placing a plurality of magnets 12 on the outermost boundary of an area or yard 20 within which dogs and/or other domestic animals are required to remain. When a dog 18 wearing a collar 16 fitted with transceiver 14 approaches the perimeter 19, the magnetic field emitted by the magnets 12 is picked up by the transceiver 14, and the alerting means within the transceiver 14 emits an auditory signal warning the dog 18 fitted with collar 16 that it is nearing the perimeter. The volume and tempo of recurrence of the auditory signals emitted by the alerting means increase as the dog 18 comes into closer proximity with the perimeter 19.

When the dog 18 comes too close or crosses perimeter 19, the stimulus generator within the transceiver 14 is activated, and a static pulse is delivered to the dog 18, thereby training the dog that the perimeter 19 should not be crossed or approached. The strength of the pulse delivered by the stimulus generator is adjustable so that dogs of various sizes may be fitted with collars containing the device, and so that dogs that are not responsive to the relatively low intensity of the static pulse could also be trained by increasing the intensity of the static pulse delivered when the perimeter is crossed.

The containment device can also be used to repel dogs or other animals fitted with the transceiver from certain areas or items in and around the house, by affixing or placing a magnet proximate to an item like a garbage bin, irrigation sprinkler or other any other item that attracts unwanted attention from animals. The dog or other animal fitted with the transceiver will accordingly be repelled from chewing or otherwise damaging or affecting such items by the auditory signal and static pulse emitted from the alerting means within transceiver when the animal approaches such areas or items.

As mentioned above, the magnets may be affixed or placed proximate to a feature in and around the house, or it could be buried underground. Due to the perimeter of the device not having to be in a continuous loop or connected to an energiser or generator, it is possible to define certain avenues or areas in and around the house where animals may or may not be present with relative ease. It is accordingly possible to allow animals to move around the house and garden, and to prevent the animals from entering certain rooms, sections or other areas of the house and garden where the presence of the animals is undesirable.

It is further also foreseen that the transceiver could be worn by livestock to prevent livestock from leaving pens or holding areas having perimeters set by surrounding the area within which the livestock are required to remain with a plurality of magnets, without having to erect costly fenced enclosures.

It is even further foreseen that the magnets may be polarly directed when placed around the garden, so that for instance, when a plurality of magnets are placed with their north poles facing upward, the transceiver is activated, and when a magnet is placed so that the opposite south pole is facing upwards, the transceiver will not be activated and the animal will be able to pass a point where such magnet is placed (not shown). Furthermore, different animals could wear containment devices wherein the transceiver is either activated by the south pole of a magnet or the north pole of a magnet (not shown). In this way, an animal wearing a transceiver being activated by magnet wherein the north pole is facing upward could be prevented from entering an area by using the containment device, but another animal wearing a transceiver activated by a magnet wherein the south pole is facing upward could be allowed access to this particular area, and vice versa.

The disadvantage of having to erect perimeter fences or walls to contain animals is accordingly overcome with the animal containment device according to the invention.

The disadvantage associated with known electronic fences being relatively cumbersome to install is accordingly alleviated, due to the fact that the magnets do not need to be installed in a continuous loop as is the case with the wire of the electronic fences. Although the magnets could also be buried, the disadvantage of having to bury the entire looped wire associated with known electronic fences is accordingly also overcome by the magnets being separate from each other, and not having to be in a continuous loop. Some of the magnets on a perimeter line may accordingly be buried, whilst others may be affixed to or placed under features in and around the house. The disadvantage of the wired loop being severed by excavation and other gardening activities is accordingly also overcome, as well as the disadvantage of limited customisability.

The further disadvantage of the requirement of an electrical supply, such as the case in known electronic pet fences, is accordingly overcome by the present invention in that a permanent magnet can be used to set up the perimeter. This negates the requirement of an electrical supply to maintain operation of the system and the requirement of a back-up electrical supply.

The disadvantage associated with known electronic pet fences wherein more than one signal energiser or generator and looped wire has to be installed if more than one perimeter is to be set is accordingly overcome by the device according to the invention not requiring any signal energiser, generator or looped wire to set a perimeter. A multitude of magnets may be placed in and around the house that will all emit magnetic fields that will be sensed by the transceiver when the animal wearing a collar provided with a transceiver comes into proximity of the respective magnets, thereby creating the possibility of setting various perimeters in and around the house using only one transceiver and a plurality of relatively inexpensive magnets. The disadvantage of known electronic pet fences being relatively costly is accordingly also overcome, and due to magnets being relatively more resistant to corrosion than the wire of the electronic pet fences, the problem associated with wire of known electronic pet fences corroding and eventually breaking is accordingly also overcome.

It is accordingly asserted that the disadvantages associated with known devices for containing animals could be alleviated with the animal containment device according to the invention.

It will be appreciated that in terms of the invention, variations in details are possible without departing from the scope of the appended claims.

1-14. (canceled)

15. An animal containment device comprising:
at least one permanent magnet, for setting a perimeter; and
a transceiver securable to an animal, the transceiver configured to detect a magnetic field emitted from the permanent magnet, the transceiver further being provided with alerting means, wherein the alerting means is configured to emit a signal when the transceiver is activated by the magnetic field, with the signal dissuading the animal from breaching the perimeter.

16. An animal containment device according to claim 15, wherein the permanent magnet is selected from the group consisting of neodymium iron boron magnets; samarium cobalt magnets; alnico magnets and ceramic magnets.

17. An animal containment device according to claim 15, wherein a plurality of magnets are provided which are polarly directed in a same or alternating directions.

18. An animal containment device according to claim 15, wherein the magnets are located underground to set the perimeter.

19. An animal containment device according to claim 15, wherein the magnets are affixed to or placed proximate a structure to set the perimeter.

20. An animal containment device according to claim 15, wherein the strength of the signal is adjustable.

21. A method for containing animals within a set perimeter comprising the steps of:
setting a perimeter using at least one permanent magnet;
securing a transceiver, configured to detect a magnetic field and further being provided with alerting means, to the animal; and
the alerting means emitting a signal when the transceiver detects the magnetic field.
